(19) United States
(12) Patent Application Publication
(10) Pub. No.: US 2015/0309620 A1
(43) Pub. Date: Oct. 29, 2015

(54) TOUCH PANEL

(71) Applicant: TIANJIN FUNAYUANCHUANG TECHNOLOGY CO.,LTD., Tianjin (CN)

(72) Inventors: PO-SHENG SHIH, New Taipei (TW); CHIH-HAN CHAO, New Taipei (TW); CHIEN-YUNG CHENG, New Taipei (TW); LYAN-YAN CHEN, New Taipei (TW); HAN-CHUNG CHEN, New Taipei (TW); CHI-JEN HUANG, New Taipei (TW)

(21) Appl. No.: 14/694,936

(22) Filed: Apr. 23, 2015

(30) Foreign Application Priority Data
Apr. 25, 2014 (CN) 201410170918.0

(51) Int. Cl. G06F 3/044; G06F 3/0354; G06F 3/0488; G06F 3/041; G06F 3/047

(52) U.S. Cl. CPC G06F 3/044; G06F 3/0412; G06F 3/047; G06F 3/04883; G06F 3/03545; G06F 3/0416; G06F 2203/04101; G06F 2203/04104; G06F 2203/04111; G06F 2203/04112; G06F 2203/04103

(57) ABSTRACT

The disclosure relates to a touch panel. The touch panel includes a conductive layer including a number of first electrodes, a number of second electrodes and a number of conductive wires. Each first electrode and second electrode is electrically connected to one conductive wire. Each first electrode includes at least one first bus bar extending along a Y direction, and each second electrode includes at least one second bus bar extending along the Y direction. The first bus bars and the second bus bars are alternately arranged along a X direction. The touch panel further includes a first offset electrode adjacent to an edge of the conductive layer, spaced from the outermost first bus bar, and electrically connected to one of the second bus bars that is adjacent to the outermost first bus bar. The first offset electrode includes a third bus bar extending along the Y direction.

### CROSS-REFERENCE TO RELATED APPLICATIONS

This application claims all benefits accruing under 35 U.S.C. §119 from China Patent Applications: Application No. 201410170918.0, filed on Apr. 25, 2014, in the China Intellectual Property Office, disclosures of which are incorporated herein by references.

### FIELD

The subject matter herein generally relates to a touch panel, especially a capacitance-type touch panel.

### BACKGROUND

Different types of touch panels, including a resistance-type, a capacitance-type, an infrared-type and a surface sound wave-type have been developed. The capacitance-type touch panel is widely used. A single layer triangle pattern (SLTP) capacitance-type touch panel usually includes a substrate, a conductive layer, an optically clear adhesive (OCA) layer, a cover lens and a plurality of conductive wires. The substrate, the conductive layer, the optically clear adhesive layer, and the cover lens are stacked. The plurality of conductive wires are located on a surface of the substrate and electrically connected to the conductive layer.

As shown in FIG. 15, a conventional SLTP capacitance-type touch panel includes a conductive layer 110 including a plurality of first electrodes 112 and a plurality of second electrodes 114. The plurality of first electrodes 112 and the plurality of second electrodes 114 are alternately located and spaced from each other. One of the plurality of first electrodes 112 and one of the plurality of second electrodes 114 that is adjacent to the one of the plurality of first electrodes 112 form an electrode pair. Each one of the plurality of first electrodes 112 is usually a trapezoidal or a triangular indium tin oxide (ITO) layer and electrically connected to one of the plurality of conductive wires 120, and each one of the plurality of second electrodes 114 is also a trapezoidal or a triangular ITO layer and electrically connected to one of the plurality of conductive wires 120. As shown in FIG. 16, each of the first electrode 112 and the second electrode 114 is a two furcate shaped. One of the plurality of first electrodes 112 and one of the plurality of second electrodes 114 are interdigitated with each other to form the electrode pair.

However, in use of the SLTP capacitance-type touch panel, for example in the process of inputting by handwriting, at edges of the touch panel, when the conductive object, such as finger or touch control pen, moves along a direction perpendicular with the edge of the touch panel, there would be an obvious deviation between the actual moving path 150 of the conductive object and the coordinates track 160 obtained by a software algorithm. A method for solving the problem is to offset by calculus filter. However, the method of calculus filter can only reduce the deviation, and can not effectively eliminate the deviation.

What is needed, therefore, is to provide a capacitance-type touch panel which can overcome the shortcomings as described above.

### BRIEF DESCRIPTION OF THE DRAWINGS

Implementations of the present technology will now be described, by way of example only, with reference to the attached figures, wherein:

FIG. 1 is a schematic view of a touch panel of example 1.

FIG. 2 is a schematic view of electrodes and conductive wires of a touch panel of example 1.

FIG. 3 is a schematic view of electrodes and conductive wires of a touch panel of example 2.

FIG. 4 is a schematic view of electrodes and conductive wires of a touch panel of example 3.

FIG. 5 is a schematic view of electrodes and conductive wires of a touch panel of example 4.

FIG. 6 is a schematic view of electrodes and conductive wires of a touch panel of example 5.

FIG. 7 is a schematic view of electrodes and conductive wires of a touch panel of example 6.

FIG. 8 is a schematic view of electrodes and conductive wires of a touch panel of example 7.

FIG. 9 is a schematic view of electrodes and conductive wires of a touch panel of example 8.

FIG. 10 is a layout view of a tested touch panel after offset design.

FIG. 11 is an enlarged view of top left corner of the layout view of FIG. 10.

FIG. 12 is an enlarged view of bottom left corner of the layout view of FIG. 10.

FIG. 13 is a schematic view of the actual moving path of the conductive object and the coordinates track obtained by a software algorithm of the tested touch panel after offset design.

FIG. 14 is a schematic view of the actual moving path of the conductive object and the coordinates track obtained by a software algorithm of a tested touch panel before offset design.

FIG. 15 is a schematic view of trapezoidal or triangular electrodes and conductive wires of a touch panel of prior art.

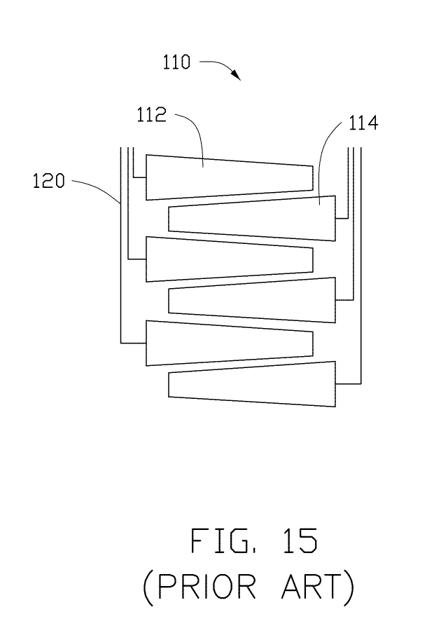

FIG. 16 is a schematic view of two furcate shaped electrodes and conductive wires of a touch panel of prior art.

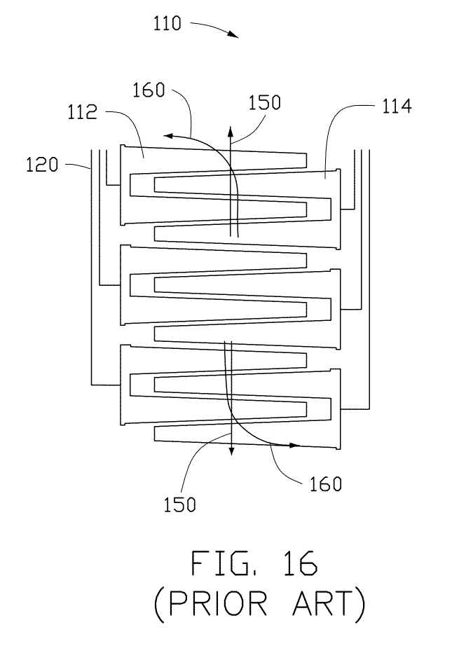

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like. It should be noted that references to “an” or “one” embodiment in this disclosure are not necessarily to the same embodiment, and such references mean at least one.

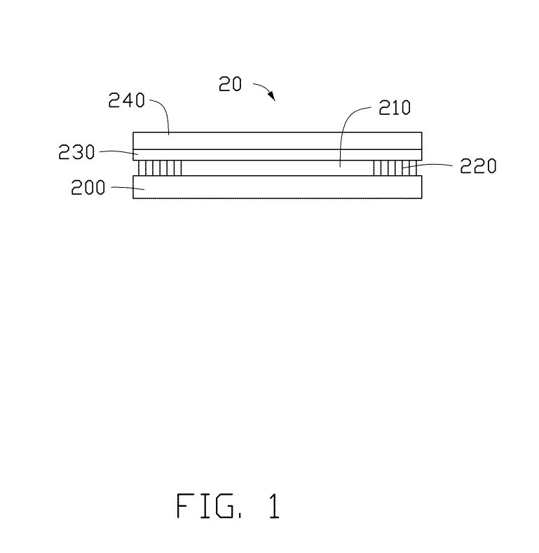

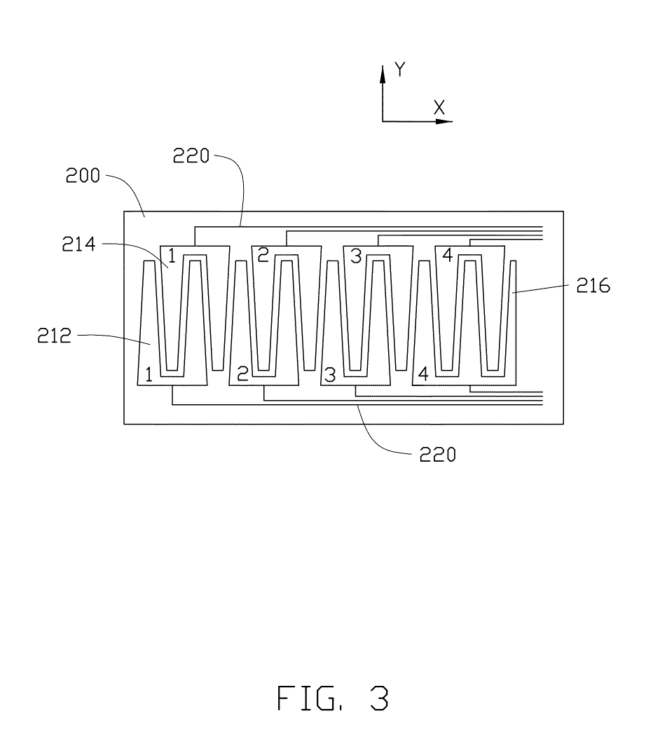

This disclosure relates to an SLTP capacitance-type touch panel. As shown in FIG. 1, the SLTP capacitance-type touch panel 20 usually includes a substrate 200, a conductive layer 210, a plurality of conductive wires 220, an OCA layer 230, and a cover lens 240. It is understood that the solution for solving the deviation between the actual moving path of the conductive object and the coordinates track obtained by a software algorithm is to design at least one offset electrode and/or offset conductive wire. Thus, the SLTP capacitance-type touch panel 20 is not limited to the structure of FIG. 3. The substrate 200, the OCA layer 230 and the cover lens 240 are optional.

The substrate 200, the conductive layer 210, the OCA layer 230, and the cover lens 240 are stacked in that order. The plurality of conductive wires 220 are located on a surface of the substrate 200 and electrically connected to the conductive layer 210. In one embodiment, the conductive layer 210 and the plurality of conductive wires 220 are located on the same surface of the substrate 200. The plurality of conductive wires 220 are distributed on two opposite sides of the conductive layer 210. The OCA layer 230 covers the plurality of conductive wires 220 and the conductive layer 210. The cover lens 240 is located on a surface of the OCA layer 230 and fixed on the substrate 200 by the OCA layer 230. Also, other function layer can be introduced according to need.

The substrate 200 can be a curved or planar sheet configured to support other elements. The substrate 200 can be transparent or opaque. The substrate 200 can be flexible or rigid. The substrate 200 can be made of rigid materials such as silicon wafer, ceramic, glass, quartz, diamond, metal oxide, plastic or any other suitable material. The substrate 200 can be made of flexible materials such as polycarbonate (PC), polymethyl methacrylate acrylic (PMMA), polyethylene terephthalate (PET), polyether polysulfones (PES), polyvinyl polychloride (PVC), benzocyclobutenes (BCB), polyesters, polyimide (PI), polyethylene (PE), acrylonitrile-butadiene-styrene copolymer (ABS), polyamide (PA), polybutylene terephthalate (PBT), acrylic resins, or mixture thereof. The mixture can be PC/ABS, PC/PBT, PC/PET, or PC/PMMA. The substrate 200 can also be a printed-wiring board (PWB). The OCA layer 230 can be transparent or opaque. In one embodiment, the OCA layer 230 is a clear and transparent double-sided adhesive tape with a light transmittance greater than 99%. The cover lens 240 can be transparent or opaque. In one embodiment, the cover lens 240 can be made of material same as that of the substrate 200. The shape, size and thickness of the substrate 200, the OCA layer 230 and the cover lens 240 can be selected according to need.

The plurality of conductive wires 220 can be made of conductive material such as metal, carbon nanotubes, ITO or conductive silver paste. The plurality of conductive wires 220 can be made by etching conductive film, such as metal film or ITO film, or screen printing conductive silver paste.

The conductive layer 210 is a pattern conductive layer. The material of the conductive layer 210 can be metal, conductive polymer, carbon nanotubes or transparent conductive oxide (TCO), such as ITO, indium zinc oxide (IZO), aluminum zinc oxide (AZO), zinc oxide (ZnO) or tin oxide (TO).

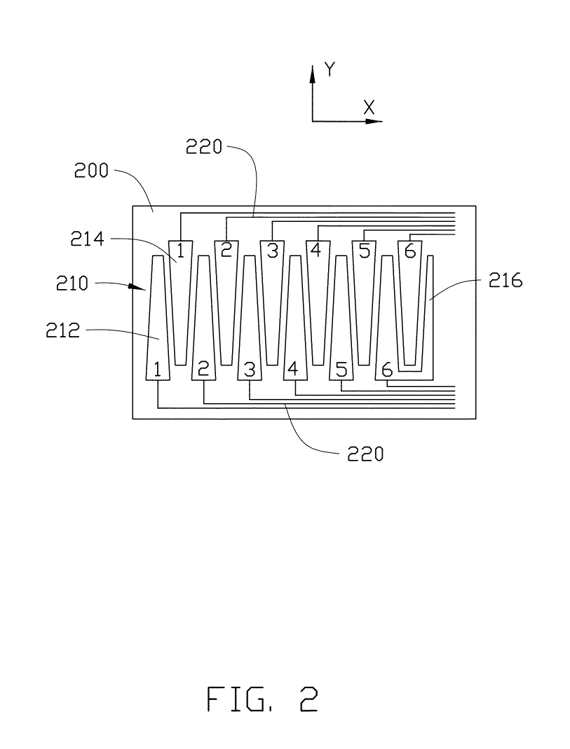

As shown in FIG. 2, the conductive layer 210 includes a plurality of first electrodes 212 and a plurality of second electrodes 214. The plurality of first electrodes 212 and the plurality of second electrodes 214 are alternately located on the same surface of the substrate 200 and spaced from each other along the direction X. One of the plurality of first electrodes 212 and adjacent one of the plurality of second electrodes 214 form an electrode pair. Each one of the plurality of first electrodes 212 and the plurality of second electrodes 214 is electrically connected to one of the plurality of conductive wires 220. Each one of the plurality of first electrodes 212 and the plurality of second electrodes 214 includes a bus bar extending along direction Y that is perpendicular to direction X. Two opposite ends of the bus bar have different widths. The bus bar can be a triangle, such as right angle triangle or isosceles triangle. The bus bar can also be a trapezoid, such as right angle trapezoid or an isosceles trapezoid.

As shown in FIG. 3-9, each one of the plurality of first electrodes 212 and the plurality of second electrodes 214 can also includes two or more than two bus bars and has a furcate shape, such as two furcate shape or three furcate shape. In each electrode pair, the first electrode 212 and the second electrode 214 are interdigitated with each other. In one embodiment, the width of each bus bar of the first electrode 212 gradually reduces along the direction +Y, and the width of each bus bar of the second electrode 214 gradually reduces along the direction −Y. The bus bars of the first electrode 212 and the bus bars of the second electrode 214 are alternately located. In one embodiment, the number, the shape and the size of the first electrode 212 and the second electrode 214 are the same.

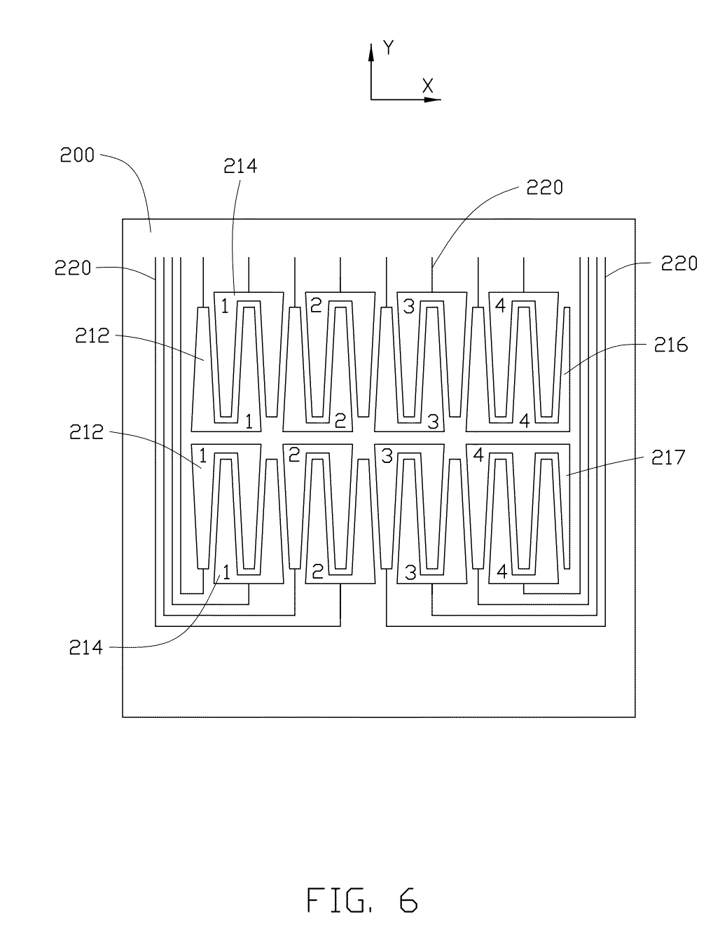

As shown in FIG. 2-5, the plurality of first electrodes 212 and the plurality of second electrodes 214 can be arranged along direction X to form a single row. As shown in FIG. 6-9, the plurality of first electrodes 212 and the plurality of second electrodes 214 can be arranged along direction X to form a plurality of rows. In each row, the plurality of first electrodes 212 and the plurality of second electrodes 214 are overlapped along direction X. In each row, the one of the plurality of first electrodes 212 that has a bus bar located on outermost left side of the row is defined as a left-side electrode, and the one of the plurality of second electrodes 214 that has a bus bar located on outermost right side of the row is defined as a right-side electrode.

As shown in FIG. 2-9, the conductive layer 210 further includes at least one offset electrode 216, 217, 218, 219. The offset electrode 216, 217, 218, 219 is at least located on the right of the right-side electrode or on the left of the left-side electrode. The offset electrode 216, 217, 218, 219 is a bus bar extending along direction Y and has different width on two opposite ends. The offset electrode 216, 217, 218, 219 can be a triangle, such as right angle triangle or isosceles triangle. The offset electrode 216, 217, 218, 219 can also be a trapezoid, such as right angle trapezoid or an isosceles trapezoid. By the offset electrode 216, 217, 218, 219, the deviation between the actual moving path of the conductive object and the coordinates track obtained by a software algorithm can be effectively reduced or eliminated. The width of the offset electrode 216, 217, 218, 219 along direction X is less than that of the first electrode 212 or the second electrode 214.

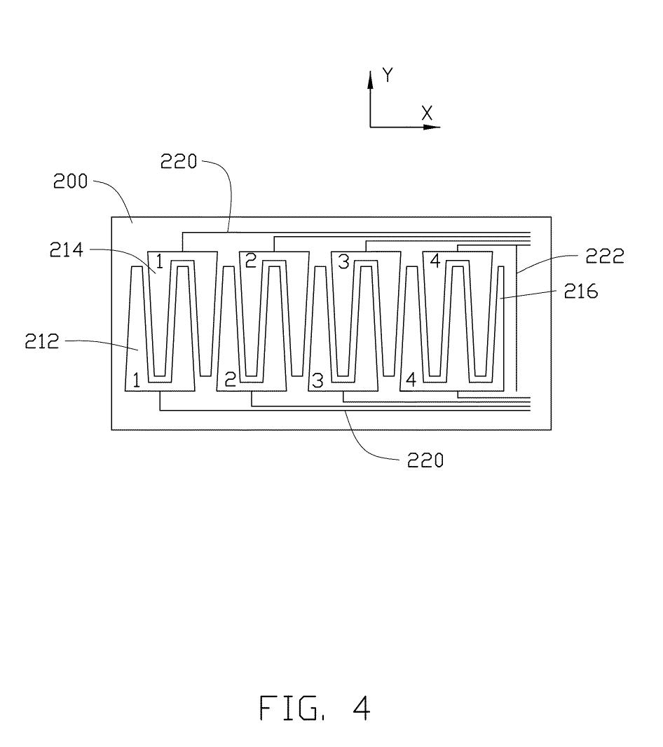

As shown in FIGS. 4, 7 and 9, the touch panel 20 can further include at least one offset conductive wire 222, 223, 224, 225 located corresponding one the offset electrode 216, 217, 218, 219. The offset conductive wire 222, 223, 224, 225 is located between the offset electrode 216, 217, 218, 219 and the edge of the substrate 200 and spaced from the offset electrode 216, 217, 218, 219. By the offset conductive wire 222, 223, 224, 225, the deviation between the actual moving path of the conductive object and the coordinates track obtained by a software algorithm can be further reduced or eliminated.

The offset electrode 216, 217, 218, 219 and the offset conductive wire 222, 223, 224, 225 can be formed together with the conductive layer 210 and the plurality of conductive wires 220 by etching an ITO film.

Different examples of the touch panel 20 are provided below.

### EXAMPLE 1

As shown in FIG. 1, in example 1, the substrate 200 and the cover lens 240 are planar glass plate. The material of the OCA layer 230 is organic glass or acrylic. The conductive layer 210 and the plurality of conductive wires 220 are made by laser etching an ITO film. Each of the plurality of conductive wires 220 is electrically connected to one of the plurality of first electrodes 212 or one of the plurality of second electrodes 214. Half of the plurality of conductive wires 220 are electrically connected to the plurality of first electrodes 212 and located on the same side of the conductive layer 210. The other half of the plurality of conductive wires 220 are electrically connected to the plurality of second electrodes 214 and located on the other same side of the conductive layer 210. The line width of each of the plurality of conductive wires 220 is in a range from about 70 micrometers to about 200 micrometers, and the pitch between adjacent two of the plurality of conductive wires 220 is in a range from about 80 micrometers to about 120 micrometers.

As shown in FIG. 2, the substrate 200 is rectangle. The length direction of the substrate 200 is defined as the direction X, and the width direction of the substrate 200 is defined as the direction Y. The conductive layer 210 includes six first electrodes 212 and six second electrodes 214 alternately located along direction X. Each of the first electrodes 212 and the second electrodes 214 is a single bar shaped isosceles trapezoid having a length much longer than bottom width.

The six first electrodes 212 and the six second electrodes 214 are respectively labeled as numbers 1, 2, 3, 4, 5, 6 along direction X. The first electrode 212 of number 1 is the left-side electrode, and the second electrode 214 of number 6 is the right-side electrode. The conductive layer 210 further includes a first offset electrode 216 located between the second electrode 214 of number 6 and the edge of the substrate 200, spaced from the second electrode 214 of number 6, and joined with the first electrode 212 of number 6 to form an integrated structure. Both the first offset electrode 216 and the first electrode 212 are bar shaped isosceles trapezoid. The top width of the first offset electrode 216 along direction X is less than that of the first electrode 212. The bottom width of the first offset electrode 216 along direction X is less than or equal to that of the first electrode 212.

### EXAMPLE 2

As shown in FIG. 3, the touch panel of example 2 is similar to the touch panel of example 1 except that the conductive layer 210 includes four first electrodes 212 and four second electrodes 214 alternately located along direction X. Each, of the first electrodes 212 and second electrodes 214, is two furcate shaped. In each electrode pair, the first electrode 212 and the second electrode 214 are interdigitated. The four first electrodes 212 and the four second electrodes 214 are respectively labeled as numbers 1, 2, 3, 4, along direction X. The first electrode 212 of number 1 is the left-side electrode, and the second electrode 214 of number 4 is the right-side electrode. The first offset electrode 216 is located between the second electrode 214 of number 4 and the edge of the substrate 200, spaced from the second electrode 214 of number 4, and joined with the first electrode 212 of number 4 to form an integrated structure.

The top width of the first offset electrode 216 along direction X is less than that of a single bus bar of the first electrode 212. The bottom width of the first offset electrode 216 along direction X is less than that of a single bus bar of the first electrode 212.

### EXAMPLE 3

As shown in FIG. 4, the touch panel of example 3 is similar to the touch panel of example 2 except that further includes a first offset conductive wire 222 located between the first offset electrode 216 and the edge of the substrate 200, spaced from the first offset electrode 216, and electrically connected to the second electrode 214 of number 4. The first offset conductive wire 222 includes a first end electrically connected to one of the conductive wires 220 which is electrically connected to the second electrode 214 of number 4, and a second end opposite to the first end and being a free end. The first offset conductive wire 222 is linear. The width of the first offset conductive wire 222 is 0.1 times to 10 times that of the conductive wire 220. The length of the first offset conductive wire 222 along direction Y is longer than that of the first offset electrode 216. The distance between the first offset conductive wire 222 and the first offset electrode 216 is in a range from about 0.01 times to 10 times the pitch between adjacent two of the plurality of conductive wires 220. In this example, the distance between the first offset conductive wire 222 and the first offset electrode 216 is about 3 times the pitch between adjacent two of the plurality of conductive wires 220, and the width of the first offset conductive wire 222 is the same as that of the conductive wire 220.

### EXAMPLE 4

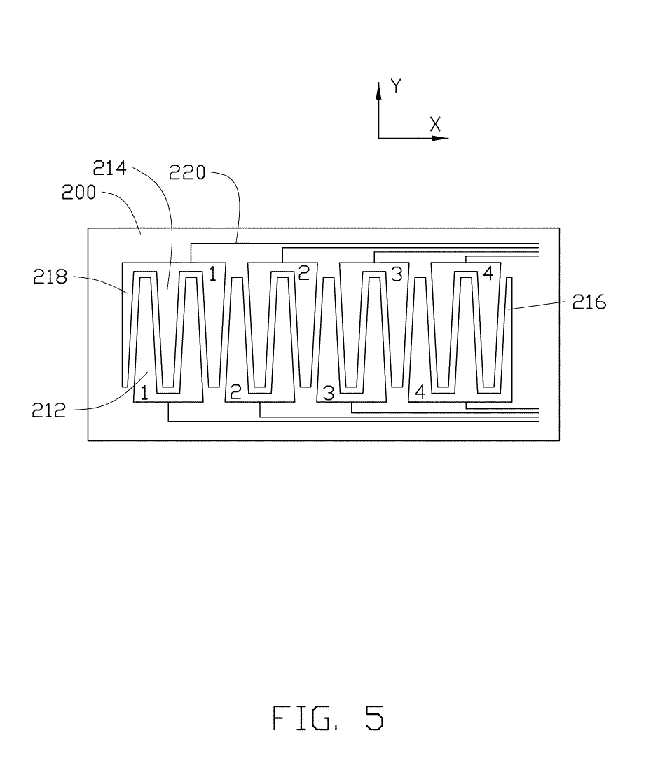

As shown in FIG. 5, the touch panel of example 4 is similar to the touch panel of example 2 except that the conductive layer 210 further includes a second offset electrode 218 located between the first electrode 212 of number 1 and the edge of the substrate 200, spaced from the first electrode 212 of number 1, and joined with the second electrode 214 of number 1 to form an integrated structure. The second offset electrode 218 is the same as the first offset electrode 216. Because two offset electrodes 216, 218 are located on different edges of the substrate 200, the deviation between the actual moving path of the conductive object and the coordinates track obtained by a software algorithm at the two edges of the touch panel can be further reduced or eliminated.

### EXAMPLE 5

As shown in FIG. 6, the touch panel of example 5 is similar to the touch panel of example 2 except that the plurality of first electrodes 212 and the plurality of second electrodes 214 are arranged along direction X to form a first row and a second row. Each row includes four first electrodes 212 and four second electrodes 214 alternately located along direction X. The pattern of the first row of the first electrodes 212 and the second electrodes 214 is a mirror image of the pattern of the second row of the first electrodes 212 and the second electrodes 214. The pattern of the first offset electrode 216 is a mirror image of the pattern of the third offset electrode 217.

### EXAMPLE 6

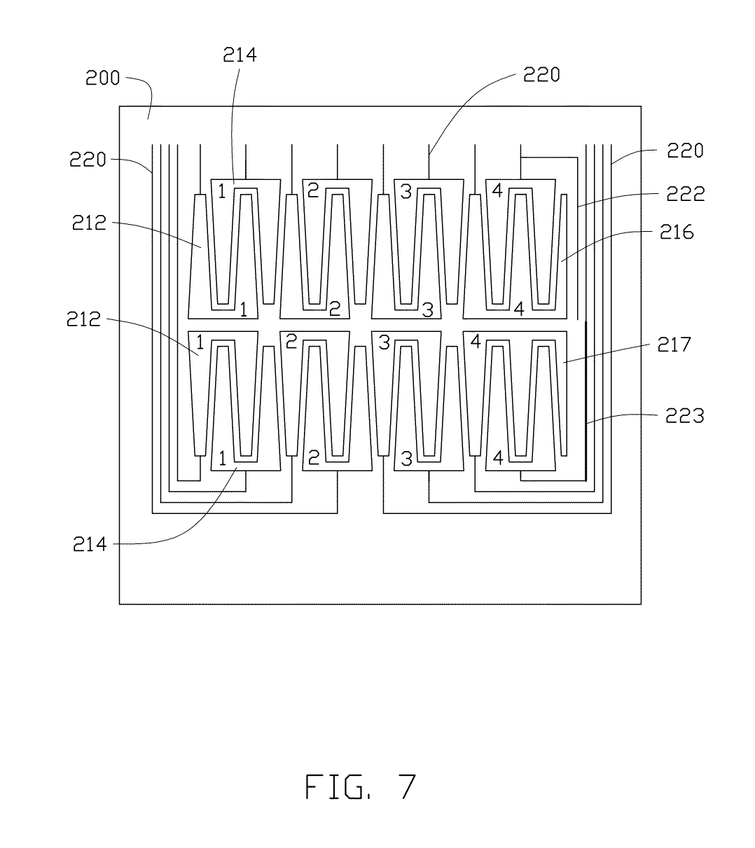

As shown in FIG. 7, the touch panel of example 6 is similar to the touch panel of example 5 except that further includes a first offset conductive wire 222 in the first row and a third offset conductive wire 223 in the second row. The first offset conductive wire 222 is located between the first offset electrode 216 and the edge of the substrate 200, spaced from the first offset electrode 216, and electrically connected to the second electrode 214 of number 4 of the first row. The third offset conductive wire 223 is located between the third offset electrode 217 and the edge of the substrate 200 and spaced from the third offset electrode 217. The third offset conductive wire 223 is a broaden part of the conductive wire 220 which is electrically connected to the second electrode 214 of number 4 of the second row. If the conductive wire 220 that is adjacent to the offset conductive wire is electrically connected to the offset electrode corresponding to the offset conductive wire, the width of the offset conductive wire need to be greater than that of the conductive wire 220. The width of the third offset conductive wire 223 can be about 2 times to 10 times the width of the conductive wire 220. In this example, the width of the third offset conductive wire 223 is 2 times the width of the conductive wire 220.

### EXAMPLE 7

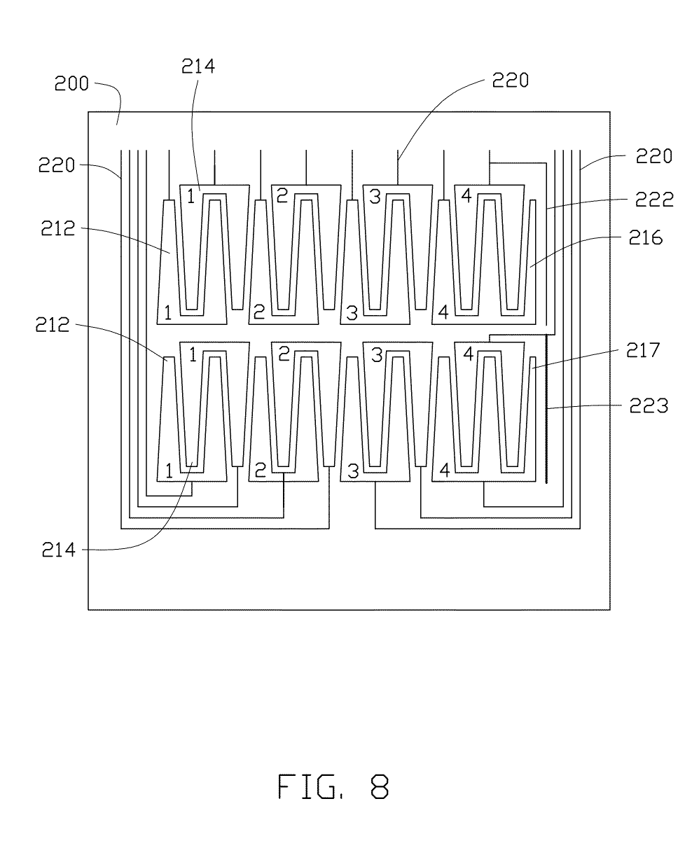

As shown in FIG. 8, the touch panel of example 7 is similar to the touch panel of example 5 except that the pattern of the first row of the first electrodes 212 and the second electrodes 214 is the same as the pattern of the second row of the first electrodes 212 and the second electrodes 214. The pattern of the first offset electrode 216 is the same as the pattern of the third offset electrode 217. The third offset conductive wire 223 is located between the third offset electrode 217 and the edge of the substrate and electrically connected to the second electrodes 214 of number 4 in the second row. The third offset conductive wire 223 is not part of the conductive wire 220. However, one end of the third offset conductive wire 223 is electrically connected to the second electrodes 214 of number 4 by the conductive wire 220, and the other end of the third offset conductive wire 223 is a free end. Because the conductive wire 220 that is adjacent to the third offset conductive wire 223 is electrically connected to the third offset electrode 217, the width of the third offset conductive wire 223 need to be greater than that of the conductive wire 220. In this example, the width of the third offset conductive wire 223 is 2 times the width of the conductive wire 220. Because the conductive wire 220 that is adjacent to the first offset conductive wire 222 is not electrically connected to the first offset electrode 216, the width of the first offset conductive wire 222 can be the same as or less than that of the conductive wire 220.

### EXAMPLE 8

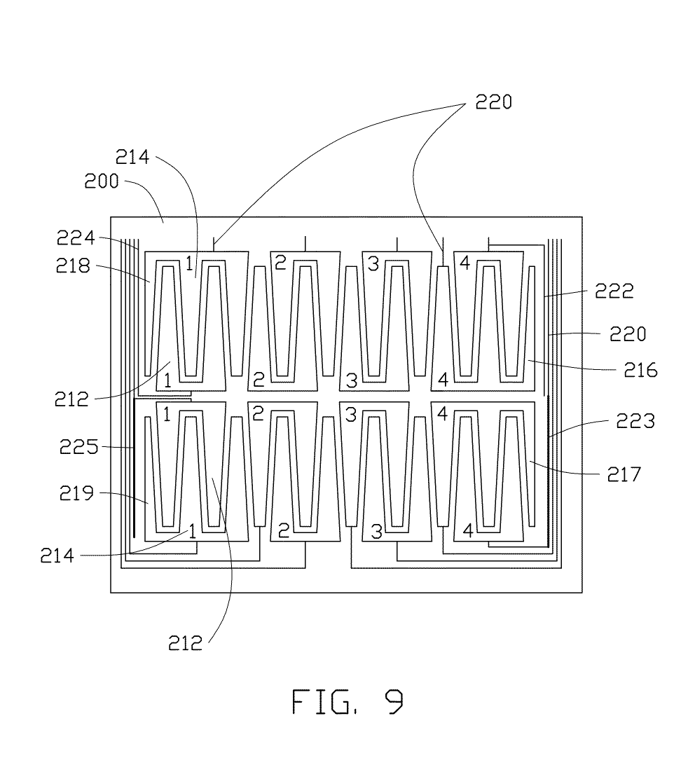

As shown in FIG. 9, the touch panel of example 8 is similar to the touch panel of example 6 except that further includes a second offset electrode 218 in the first row, a fourth offset electrode 219 in the second row, a second offset conductive wire 224 in the first row, and a fourth offset conductive wire 225 in the second row. The second offset electrode 218 is joined with the second electrode 214 of number 1 of the first row to form an integrated structure and spaced from the first electrode 212. The fourth offset electrode 219 is joined with the second electrode 214 of number 1 of the second row to form an integrated structure and spaced from the first electrode 212. The second offset conductive wire 224 is part of the conductive wire 220 which is electrically connected to the first electrode 212 of number 1 of the first row and spaced from the second offset electrode 218. The fourth offset conductive wire 225 is spaced from the fourth offset electrode 219 and electrically connected to the first electrode 212 of number 1 of the second row by the conductive wire 220. One end of the fourth offset conductive wire 225 is electrically connected to the conductive wire 220 which is electrically connected to the first electrode 212 of number 1 of the second row, and the other end of the fourth offset conductive wire 225 is a free end.

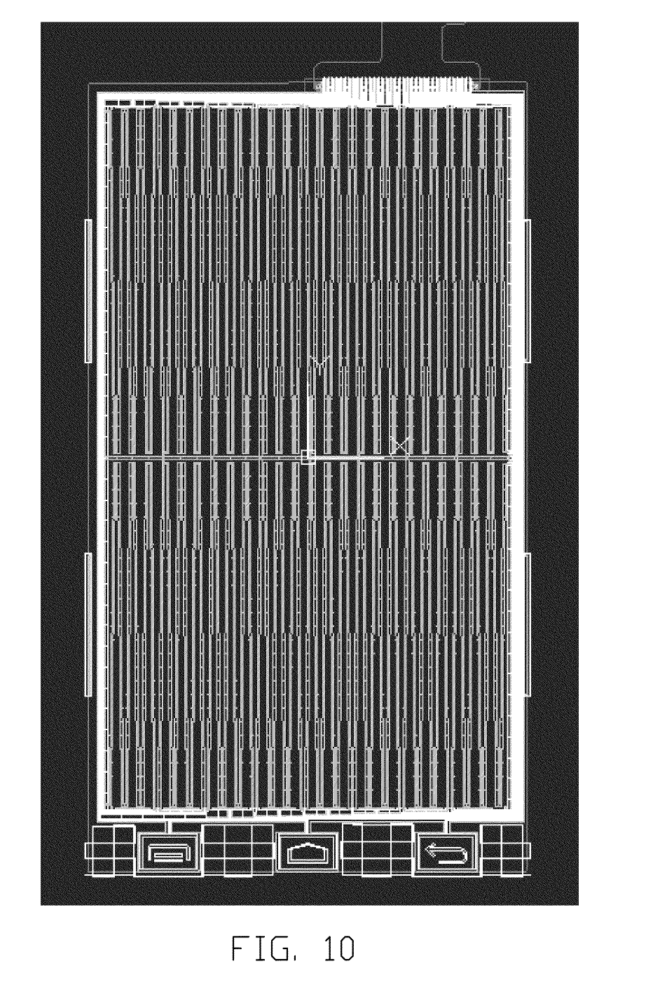

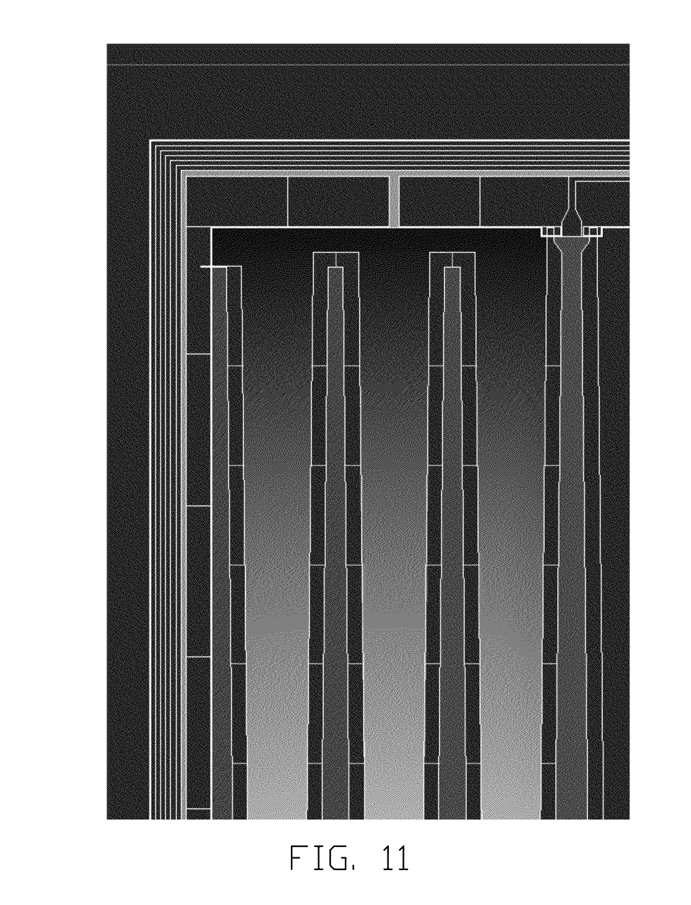

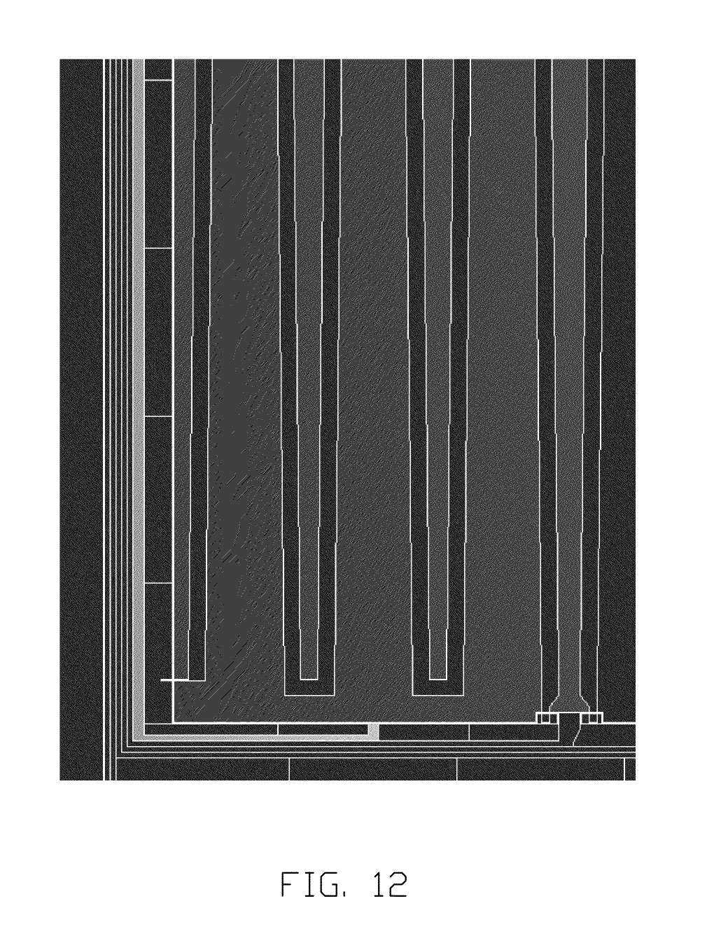

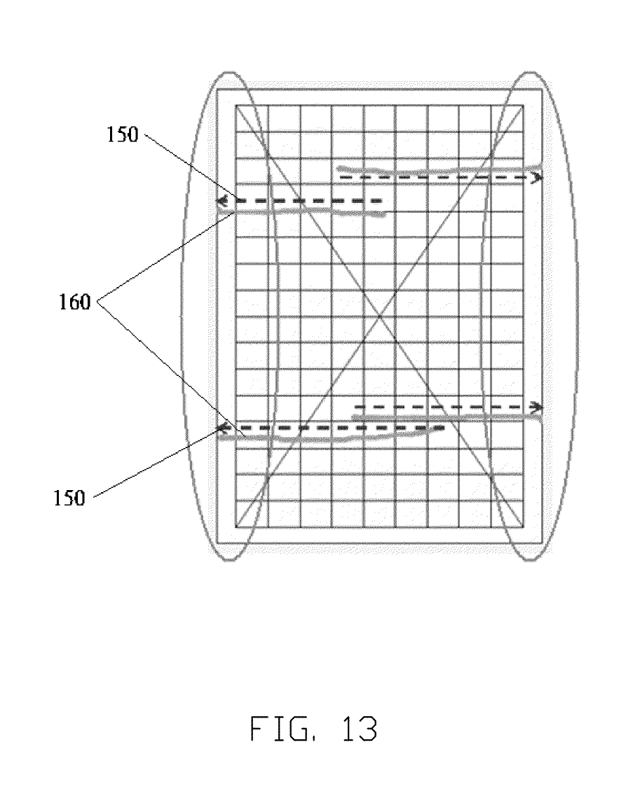

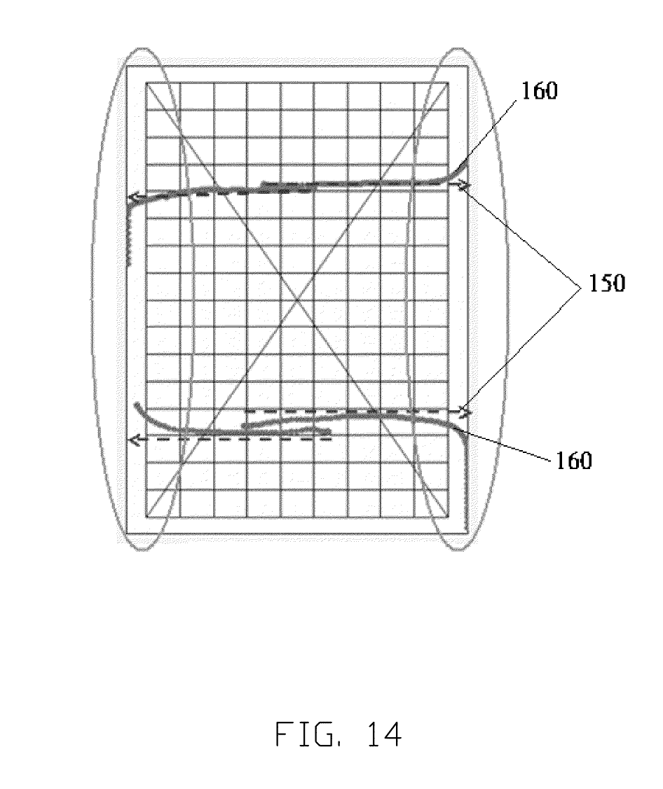

The touch panel after offset design and the touch panel before offset design are tested respectively. As shown in FIGS. 10-12, the tested touch panels include two rows of first electrodes and second electrodes. Each of the first electrodes and second electrodes is three furcate shaped. The tested touch panel after offset design and the tested touch panel before offset design have the same structure except the offset electrodes and the offset conductive wires. As shown in FIG. 13, in the tested touch panel after offset design, the actual moving path 150 of the conductive object and the coordinates track 160 obtained by a software algorithm are substantially coincidental. As shown in FIG. 14, in the tested touch panel before offset design, there is an obvious deviation between the actual moving path 150 of the conductive object and the coordinates track 160 obtained by a software algorithm.

The embodiments shown and described above are only examples. Even though numerous characteristics and advantages of the present technology have been set forth in the forego description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Depending on the embodiment, certain of the steps of methods described may be removed, others may be added, and the sequence of steps may be altered. The description and the claims drawn to a method may include some indication in reference to certain steps. However, the indication used is only to be viewed for identification purposes and not as a suggestion as to an order for the steps.

What is claimed is:

1. A touch panel, comprising:
a conductive layer comprising a plurality of first electrodes and a plurality of second electrodes, wherein each of the plurality of first electrodes comprises at least one first bus bar extending along a Y direction so that the conductive layer comprises a plurality of first bus bars, and one of the plurality of first bus bars is an outermost first bus bar; and each of the plurality of second electrodes comprises at least one second bus bar extending along the Y direction so that the conductive layer comprises a plurality of second bus bars, and one of the plurality of second bus bars is an outermost second bus bar; and the plurality of first bus bars and the plurality of second bus bars are alternately arranged along a X direction;
a plurality of conductive wires, wherein each of the plurality of first electrodes is electrically connected to one of half of the plurality of conductive wires, and each of the plurality of second electrodes is electrically connected to one of the other half of the plurality of conductive wires; and
a first offset electrode adjacent to an edge of the conductive layer, spaced from the outermost first bus bar, and electrically connected to one of the plurality of second bus bars that is adjacent to the outermost first bus bar; wherein the first offset electrode comprises a third bus bar extending along the Y direction.

2. The touch panel of claim 1, wherein two opposite ends of the at least one first bus bar has different widths, two opposite ends of the at least one second bus bar has different widths, and two opposite ends of the third bus bar has different widths.

3. The touch panel of claim 1, wherein the at least one first bus bar is a triangle or trapezoid, the at least one second bus bar is a triangle or trapezoid, and the third bus bar is a triangle or trapezoid.

4. The touch panel of claim 1, wherein a shape and a size of the at least one first bus bar is the same as that of the at least one second bus bar, and a width of the third bus bar is less than that of the at least one first bus bar.

5. The touch panel of claim 1, wherein both the at least one first bus bar and at least one second bus bar are isosceles trapezoid of the same size; and a top width of the third bus bar along the direction X is less than that of the at least one first bus bar, and a bottom width of the third bus bar along the direction X is less than or equal to that that of the at least one first bus bar.

6. The touch panel of claim 1, wherein each of the plurality of first electrodes is furcate shaped and has a first furcate shape; and each of the plurality of second electrodes comprises two or more than two second bus bars and has a second furcate shape same as the first furcate shape.

7. The touch panel of claim 1, further comprising a first offset conductive wire spaced from the first offset electrode and electrically connected to the outermost first bus bar; and the first offset electrode is located between the conductive layer and the first offset conductive wire.

8. The touch panel of claim 7, wherein the first offset conductive wire comprises a first end electrically connected to the outermost first bus bar and a second end opposite to the first end and being a free end.

9. The touch panel of claim 7, wherein one of the plurality of conductive wires that is adjacent to the first offset conductive wire is electrically connected to the first offset electrode, and the first offset conductive wire has a width greater than that of the plurality of conductive wires.

10. The touch panel of claim 9, wherein the width of the first offset conductive wire is about 2 times to 10 times the width of the plurality of conductive wires.

11. The touch panel of claim 1, further comprising a second offset electrode adjacent to an edge of the conductive layer, spaced from the outermost second bus bar, and electrically connected to one of the plurality of first bus bars that is adjacent to the outermost second bus bar; wherein the second offset electrode comprises a fourth bus bar extending along the Y direction.

12. The touch panel of claim 11, further comprising a second offset conductive wire spaced from the second offset electrode and electrically connected to the outermost second bus bar; and the second offset electrode is located between the conductive layer and the second offset conductive wire.

13. The touch panel of claim 11, wherein the first offset electrode is joined to the one of the plurality of second bus bars that is adjacent to the outermost first bus bar to form a first integrated structure; and the second offset electrode is joined to the one of the plurality of first bus bars that is adjacent to the outermost second bus bar to form a second integrated structure.

14. The touch panel of claim 1, wherein the plurality of first electrodes and the plurality of second electrodes are arranged along direction X to form a first row and a second row; the first offset electrode and a second offset electrode are respectively located on two opposite sides of the first row; and a third offset electrode and a fourth offset electrode are respectively located on two opposite sides of the second row.

15. The touch panel of claim 14, wherein a first offset conductive wire and a second offset conductive wire are respectively located on two opposite sides of the first row; and a third offset conductive wire and a fourth offset conductive wire are respectively located on two opposite sides of the second row.

16. A touch panel, comprising: a conductive layer comprising a plurality of electrode pairs arranged along a X direction, wherein each of the plurality of electrode pairs comprise at least one first bus bar and at least one second bus bar spaced from each other and extending along a Y direction substantially perpendicular with the X direction so that the conductive layer comprises a plurality of first bus bars and a plurality of second bus bars; one of the plurality of first bus bars is an outermost first bus bar, and one of the plurality of second bus bars is an outermost second bus bar; the plurality of first bus bars and the plurality of second bus bars are alternately arranged along the X direction; and a first width of the at least one first bus bar gradually reduces along a direction +Y, and a second width of the at least one second bus bar gradually reduces along a direction −Y;
wherein the conductive layer further comprises a first offset electrode spaced from the outermost first bus bar and electrically connected to one of the plurality of second bus bars that is adjacent to the outermost first bus bar; wherein the first offset electrode comprises a third bus bar extending along the Y direction and having a width less than that of the outermost first bus bar.

17. The touch panel of claim 16, further comprising a first offset conductive wire spaced from the first offset electrode and electrically connected to the outermost first bus bar; and the first offset electrode is located between the conductive layer and the first offset conductive wire.

18. The touch panel of claim 17, wherein the first offset conductive wire comprises a first end electrically connected to the outermost first bus bar and a second end opposite to the first end and being a free end.

19. The touch panel of claim 16, further comprising a second offset electrode spaced from the outermost second bus bar and electrically connected to one of the plurality of first bus bars that is adjacent to the outermost second bus bar; wherein the second offset electrode comprises a fourth bus bar extending along the Y direction and having a width less than that of the outermost second bus bar.

20. The touch panel of claim 19, further comprising a second offset conductive wire spaced from the second offset electrode and electrically connected to the outermost second bus bar; and the second offset electrode is located between the conductive layer and the second offset conductive wire.
